(19) United States
(12) Patent Application Publication
(10) Pub. No.: US 2006/0157457 A1
(43) Pub. Date: Jul. 20, 2006

(54) Hybrid laser processing method and hybrid laser torch used in the method

(75) Inventors: Tsutomu Sakurai, Nara (JP); Kazuhiro Toya, Osaka (JP); Koji Funami, Kyoto (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/295,646

(22) Filed: Dec. 7, 2005

(30) Foreign Application Priority Data
Dec. 8, 2004 (JP) 2004-354887

(51) Int. Cl. B23K 26/067

(52) U.S. Cl. 219/121.76

(57) ABSTRACT

First and second laser beams from two different laser systems are superposed and irradiated as a hybrid laser beam on a workpiece. The effective spot size of second laser beam on the workpiece is smaller than that of the first laser beam. Thereby, a workpiece of a metal material having high reflectivity is processed with a sufficient weld penetration depth and width, and at high speed.

### BACKGROUND OF THE INVENTION

1. Field of the Invention

The present invention relates to a hybrid laser processing method and a hybrid laser torch used in the method, wherein a workpiece is processed with a hybrid laser beam using laser beams from two different laser systems, i.e., a solid-state laser medium such as YAG and a semiconductor laser (LD).

2. Description of the Related Art

Japanese Patent Publication No. 2000-005892 shows a laser welding method, wherein a laser beam is focused at a plurality of positions along the optical axis to achieve a desired weld penetration depth and weld width. Japanese Patent Publication No. 2002-028795 shows a method wherein two YAG laser beams are superposed so that a metal material having high reflectivity and high heat dissipation rate can be processed with a sufficient cross section and depth of weld penetration. Japanese Patent Publication No. 2003-164983 shows a method wherein a laser beam is used together with arc welding. Meanwhile, it is the common practice to provide an inactive shielding gas at the same time with laser irradiation to prevent oxidation of the molten weld pool as shown in Japanese Patent Publications Nos. 2003-164983 and 11-267876. In the method shown in Japanese Patent Publication No. 11-267876, specifically, a shielding gas is ejected from a tapered annular passage around the laser emitting end of the laser torch. At the same time, air is blown from a plurality of nozzles arranged along the optical axis to form air knives across the laser beam in the front of focusing lenses inside the torch, so as to prevent sputtered particles from the weld pool from adhering to the lenses.

To satisfy incompatible requirements of high weld penetration and high speed, new welding methods have been developed to replace these welding methods. The new methods involve superposing pulse-operated LD beam and CW-operated LD beam, or a YAG laser beam and an LD beam. Research in such new method has been made, and various test machines have been produced, some of which have actually been put in use.

A combination of two LD beams can hardly achieve a sufficient output power. More specifically, pulsed laser reduces in power after about 1,000 hours of continuous full power output, while CW laser has a maximum output of only 20 W at the processing point. Welding with these laser systems is therefore not fit for actual use yet. With respect to the welding using a hybrid laser beam of LD-pumped YAG laser and LD beam, while the processing precision and speed have been improved, it is still in a developing stage, not being able to satisfy new requirements for seal welding of aluminum products set by the car manufacturing industry.

The above-mentioned shielding technique using inactive gas has not yet proved its effectiveness. The method in Japanese Patent Publication No 2003-164983, for example, only involves blowing a jet of inactive gas to the weld pool. The blown jet of gas includes ambient air, and the air causes a sealing failure. Molten metal loses its luminance because of oxidation, which leads to weld failures and cracks. The method in Japanese Patent Publication No. 11-267876, wherein the shielding gas is blown out from the tapered annular passage around the laser emitting end of the torch, also entails the problem of entrapped air in the gas blown to the weld pool. Moreover, in the shielding gas that is converged toward the weld pool, a reversed current is easily formed, which can flow into the torch and guide the sputtered particles from the weld pool into the torch. The method in Japanese Patent Publication No. 11-267876 provides air knives to protect the focusing lenses from such particles, but even though the lenses may be protected, sputtered particles will be blown and scattered in the air around the torch, and the torch interior will be susceptible to contamination. To prevent contamination, a jet of inactive gas may be blown out from the torch, but the problem of entrapped air blown to the weld pool remains unsolved.

### SUMMARY OF THE INVENTION

In view of the problems in the conventional techniques, an object of the present invention is to provide a hybrid laser processing method and a hybrid laser torch used in the method for preocessing a metal material having high reflectivity such as aluminum can be processed with a sufficient weld penetration depth and width, and at high speed. Another object is to solve the problems caused by oxidation of the weld pool and sputtered particles.

To achieve the above object, the present invention provides a hybrid laser processing method, wherein a first laser beam and a second laser beam from two different laser systems are superposed and irradiated on a workpiece as a hybrid laser beam. The first and second laser beams are irradiated at the same time to the same position on the workpiece such that the effective spot size D2 of the second laser beam is smaller than the effective spot size D1 of the first laser beam. More specifically, the first laser beam from a solid-state laser medium and the second laser beam from an LD are superposed and irradiated as a hybrid laser beam on the workpiece, such that the effective spot size D2 of the second laser beam is smaller than that D1 of the first laser beam for processing the workpiece.

With this method, the first and second laser beams from two different laser systems are superposed and irradiated as a hybrid laser beam on the workpiece, wherein the two laser beams respectively have large and small spot sizes D1 and D2, whereby the center of the laser beam spot is processed faster than the surrounding area, which accelerates the processing and increases penetration. In a preferred embodiment, while the first laser beam with high power output achieves necessary processing width and strength, the second laser beam, which is with lower output than the first laser beam, is focused in the smaller effective spot size D2 than D1 to concentrate laser energy to a specific area. Therefore, while the first laser beam covers the entire processing width, the second laser beam increases the processing speed and depth in a more limited area, as compared to the case where both laser beams have the same focus diameter. As a result, even a metal material having high reflectivity such as aluminum is processed with a sufficient weld width, or penetration width, and penetration depth, and at high speed. Also, the processing of the specific area with accelerated speed and increased penetration using the hybrid laser beam effectively suppresses generation of sputtered particles.

The ratio of D2 to D1 should preferably be in the range of 0.2≦D2/D1≦0.8. The second laser beam should be emitted such that its effective spot is positioned inside the effective spot of the first laser beam. This way, a keyhole is formed in the spot center, which grows in depth and further accelerates the processing speed and increases penetration.

The effective spot size D2 of the second laser beam should preferably be equal to or smaller than the size D3 of the keyhole which is formed during the process. This enables further concentration of optical energy, whereby the keyhole is maintained even between pulses of the first laser beam, and porosity formation, which is caused by metal vapor entrapped in closed keyholes, is prevented.

Accordingly, the second laser beam maintains the keyhole and prevents formation of porosity which entraps metal vapor inside the keyhole when the keyhole closes fast.

This method of hybrid laser processing is performed by using a hybrid laser torch including the following: A torch main body having a laser emitting end for emitting a hybrid laser beam; a first laser introducing unit and a second laser introducing unit for introducing laser beams from two different laser systems; a first mirror and a second mirror positioned in series along an optical axis for reflecting the first and second laser beams from the first and second laser introducing units and for superposing and irradiating the first and second laser beams as a hybrid laser beam; and a focus lens system for focusing the hybrid laser beam onto a workpiece such that the effective spot size of the second laser beam is smaller than the effective spot size of the first laser beam, wherein the first laser introducing unit and the second laser introducing unit, the first mirror and the second mirror, and the focus lens system are contained in the torch main body.

With this hybrid laser torch, the first and second laser beams are independently introduced into a hybrid laser torch, superposed therein, and emitted as a hybrid laser beam onto the workpiece. Superposing the two laser beams having different characteristics into the hybrid laser beam at the last stage has the following advantages: The type of the light paths (such as optical fibers) and the core diameter may be variously changed to achieve the best effects of the characteristics of respective laser beams. The laser beam characteristics are not lost or degraded because the beams are not superposed from an earlier stage and do not travel a long common path. Also, adverse effects of high energy on the surrounding structure are avoided.

When the first mirror is positioned forward of the second mirror, the first mirror should preferably be provided with an HR coating for a laser beam from a solid-state laser medium such as a YAG laser beam and an AR coating for an LD laser beam, while the second mirror should be provided only with an HR coating for an LD laser beam. Alternatively, if the first mirror is positioned behind the second mirror, the first mirror may be provided with an HR coating for a YAG laser beam, and the second mirror may be provided with an HR coating for an LD laser beam and an AR coating for solid-state laser. These coatings, combined with different wavelengths of the laser beams and the reflection and transmission characteristics of the mirrors corresponding to their positions, reduce energy loss of the laser beams, and increase energy efficiency, irrespective of which mirror is positioned forward on the optical axis.

The first laser beam is a pulsed laser beam; its output power is controlled by adjusting laser pulses. The second laser beam is a CW laser beam output with wavelength or modulation control. More specifically, while the CW laser energy is constantly concentrated on a specific area in a necessary processing width to continuously perform a supplementary process suitable for the low output of the second laser beam, the instantaneous, high power output of the pulsed first laser beam is repeatedly applied over the entire processing area to achieve a large processing width and high speed. Meanwhile, the second laser beam proceeds the supplementary process, accelerating the processing speed and increasing penetration on the specific area. That is, the continuous emission of the CW laser surely maintains the keyhole, which may close between pulses if there is only the intermittent pulsed laser beam, whereby the processing is made stable.

Even if the effective spot size D1 of the pulsed laser beam is smaller than that D2 of the CW laser beam, a keyhole is readily formed because of a temperature rise in the spot center. However, a deeper keyhole is readily formed if the effective spot size D2 of the pulsed laser beam is smaller than the effective spot size D1 of the CW laser beam.

The means of irradiating the pulsed laser beam includes a lamp-pumped pulsed YAG, a pulse-pumped laser, and a pulsed fiber laser, and a pulsed laser beam is an intermittently output laser beam. The means of irradiating the CW laser beam includes an LD direct laser, an LD-pumped CW laser, and a CW fiber laser, and a CW laser beam is a continuously emitted laser beam.

A light source of the first laser beam is a solid-state laser medium or laser oscillator such as YAG, and the first laser beam is guided by a GI (grated index) or SI (step index) optical fiber. The second laser beam is guided by a GI optical fiber. These beams are superposed and focused onto the workpiece using the same focus lens system, which is designed to focus the first laser beam with a predetermined focus diameter. Therefore, the second laser beam is also passed through the same focus lens system, but focused with a smaller focus diameter because of a difference in the wavelength. The GI optical fiber focuses the second laser beam with a smaller focus diameter than that of the first laser beam, and the laser energy is easily concentrated to a specific area, whereby the hybrid laser beam effect in the area is enhanced. The first laser beam may also be guided by a GI optical fiber so that it is focused more easily, but only if necessary, as it can be guided with an SI optical fiber with no particular problems.

The aforementioned method is easily performed by using the hybrid laser torch when the first laser beam is a laser beam from a solid-state laser medium such as YAG, and the first laser introducing unit is connected to a light source for the first laser beam via a GI or SI optical fiber, and the second laser introducing unit is connected to a light source for the second laser beam via a GI optical fiber.

In a preferred embodiment, the processing position on the workpiece is illuminated, and its reflection light is used to form an image of the workpiece using an achromatic lens with a smaller diameter than the lenses of the focus lens system, or instead a small aperture, so that the processing state is monitored in order to adjust the processing conditions in accordance with the monitored image. When the workpiece is illuminated, the reflection light travels back through the lenses of the focus lens system and reaches the first and second mirrors, but it is passed through the first and second mirrors and guided to the outside of the optical system and used for forming an image for the monitoring purpose so that the processing conditions can be adjusted. With a colorless achromatic lens with a smaller diameter than the focus lenses or a small aperture such as a pinhole, a clear image is formed with a large focal depth, while achieving satisfactory reflection and transmission characteristics of the focus lenses and the first and second mirrors, and thus the monitoring is performed easily and appropriately. With a pinhole, the system can further be simplified in addition to the abovementioned effects.

To perform this method, the hybrid laser torch should include an illuminator for illuminating the processing position on the workpiece, an achromatic lens having a smaller diameter than the lenses of the focus lens system, or a small aperture, for forming an image using reflection light from the illuminated object that is passed through the first and second mirrors, and a monitor camera for displaying the formed image for the monitoring purpose.

In a preferred embodiment, the illuminator emits a white light from a white LED and the light beam is introduced by an optical fiber. The white LED light beam is precisely guided by the optical fiber toward the area on the workpiece that is processed with the hybrid laser beam without interfering with anything, so that, even when the processed part of the workpiece maintains a luminance surface, the white light reduces glare, and flicker-free, halation-free images of the surface of the workpiece are clearly formed in the monitor camera, for easy and correct visual recognition of the processed surface.

In a preferred embodiment, the orientation of one of the first and second mirrors is adjusted before the actual processing. A laser mark is produced on a test specimen using one laser beam through the mirror that is arranged more forward along the optical axis, and then, another laser beam is emitted through the mirror that is arranged behind the other. The mirror direction is adjusted so that the laser position of the latter laser beam is within a specified area inside the laser mark, while monitoring the image on the monitor. The first and second mirrors and the focus lens system are designed to superpose two laser beams along the optical axis and to focus the hybrid laser beam and they are set in standard relative positions, but in actual use, there may be the case where the two laser positions do not match because of various other conditions. Therefore, before actual use, the laser beams are first emitted one after another to check the laser position of one laser relative to the laser mark of the other beam from the monitor image. One of the first and second mirrors is adjusted so that the position of laser emitted afterward is moved to a correct position relative to the laser mark to match the two laser positions, whereby it is ensured that the processing afterward is carried out as intended. Since one of the first and second mirrors, which is arranged behind the other along the optical axis, i.e., away from the target, is adjusted in position, the laser position is easily adjustable because the farther the mirror is positioned from the target, the more the laser position is displaced in accordance with the mirror direction. Moreover, the mirror direction is adjusted without causing any influence on the laser beam emitted through the mirror that is arranged more forward on the optical axis.

To perform the above method, the hybrid laser torch should include a mirror adjusting unit, at least one of the mirrors that is arranged behind the other on the optical axis being supported on this adjusting unit. Depending on the case, both of the mirrors may be supported on such adjusting units. The adjusting unit may include a rotatable adjusting part that rotates around a shaft orthogonal to the optical axis for adjusting the direction of the mirror surface.

In a preferred embodiment, an inactive gas is supplied to a tapered center passage and continuously ejected as a tapered center jet, while the hybrid laser beam is being projected through the tapered center passage onto the workpiece. At the same time, a truncated-cone shaped, annular passage formed around the center passage continuously ejects an inactive gas such as to form a film current surrounding the hybrid laser beam and the center jet. The tapered center jet of inactive gas continuously ejected from the center passage through which the hybrid laser beam is projected protects the optical system from sputtered particles that may be generated at the processed area on the workpiece. As the center jet is surrounded by the film current ejected from the truncated-cone shaped, annular passage, it does not entrap air outside. When it reaches the processed surface of the workpiece, the center jet spreads while purging air, thereby causing the film current also to spread around, which keeps covering the entire surface of the spread center jet until the jet reaches the workpiece. The jet thus eliminates air between the laser emitting end and workpiece, whereby oxidation of the processed area of the workpiece is prevented, weld failures or cracks resulting from oxidation are prevented, and the processed area maintains a luminance surface.

To perform the above method, the hybrid laser torch should include a coaxial double nozzle at the laser emitting end of the torch main body. The nozzle includes a tapered center passage, which is arranged along the optical axis and through which the hybrid laser beam passes, and which ejects a supplied inactive gas continuously as a tapered center jet. The nozzle further includes a truncated-cone shaped, annular passage around the center passage, which ejects an inactive gas continuously such as to form a film current surrounding the hybrid laser beam and the center jet.

The center passage and the annular passage may be formed with outer circumferential annular passages and circumferentially arranged small holes for communicating these passages with each other, so as to fill the center passage and annular passage with supplied inactive gas in a circumferential direction.

In one embodiment, the hybrid laser torch further includes a first sensing part for sensing part of light of the first laser beam transmitted through the first mirror, and a second sensing part for sensing part of light of the second laser beam transmitted through the second mirror. The laser beams are transmitted through the mirrors in such a slight amount that it does not cause significant output loss. The energy level of the first and second laser beams is thus monitored and the data is used for determining laser output status and optical fiber transmission status.

In one embodiment, the first mirror is arranged forward of the second mirror, and the first sensing part receives light through a visible light cut filter and a filter with an HR coating for laser beams from an LD and solid-state laser medium such as YAG. The second sensing part receives light through a visible light cut filter and a filter with an HR coating for the solid-state laser beam. Alternatively, the first mirror may be arranged behind the second mirror, in which case the first sensing part receives light through a visible light cut filter and a filter with an HR coating for the LD beam. The second sensing part receives light through a visible light cut filter and a filter with an HR coating for both of the LD beam and solid-state laser beam. With this filter and coating combination, irrespective of which mirror is positioned forward, even when the first and second laser beams that have reached the workpiece and passed through the monitor camera or ambient light reach the first and second sensing parts through the first and second mirrors, these light rays are filtered away so that sensing is performed correctly.

The first and second sensing parts may further be covered by a hood to prevent adverse effects of ambient light and dust around the hybrid laser torch.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a cross-sectional view of one embodiment of a hybrid laser torch of the invention;

FIG. 2 is a side view of the hybrid laser torch;

FIG. 3 is an enlarged cross-sectional view of the vicinity of the laser emitting end of the hybrid laser torch;

FIG. 4 is a front view of a mirror adjusting unit used for both of first and second mirrors of the hybrid laser torch;

FIG. 5 is a front view of the first and second mirrors of the hybrid laser torch;

FIG. 6 is a bottom view of the laser emitting end of the hybrid laser torch;

FIG. 7 is a diagram illustrating the internal structure of first and second sensing parts of the hybrid laser torch;

FIG. 8 is a diagram for explaining how the positions of the first and second laser beams are adjusted;

FIG. 9 is a chart showing some test results of the hybrid laser torch;

FIG. 10A and FIG. 10B are diagrams illustrating two typical examples of intensity distribution of laser spots;

FIG. 11 is a schematic view of one example of laser spots of the first and second laser beams;

FIG. 12 is a diagram illustrating a processing state with a certain relation between the effective spot sizes of the first and second laser beams;

FIG. 13 is a diagram illustrating a processing state with a certain relation between the effective spot sizes of the first and second laser beams;

FIG. 14 is a diagram illustrating one example of preferable combination of laser systems: A lamp-pumped, pulsed laser and a CW fiber laser;

FIG. 15 is a diagram illustrating another example of preferable combination of laser systems: A lamp-pumped pulsed laser and an LD direct laser; and

FIG. 16 is a diagram illustrating yet another example of preferable combination of laser systems: A pulsed fiber laser and a CW fiber laser.

### DETAILED DESCRIPTION OF THE PREFERRED EMBODIMENTS

Preferred embodiments of the hybrid laser processing method and hybrid laser torch used in the method of the present invention will be hereinafter described in detail with reference to the drawings for a better understanding of the invention. It should be understood that the description of the following specific examples is given for purposes of illustration only and not intended to limit the scope of the claims.

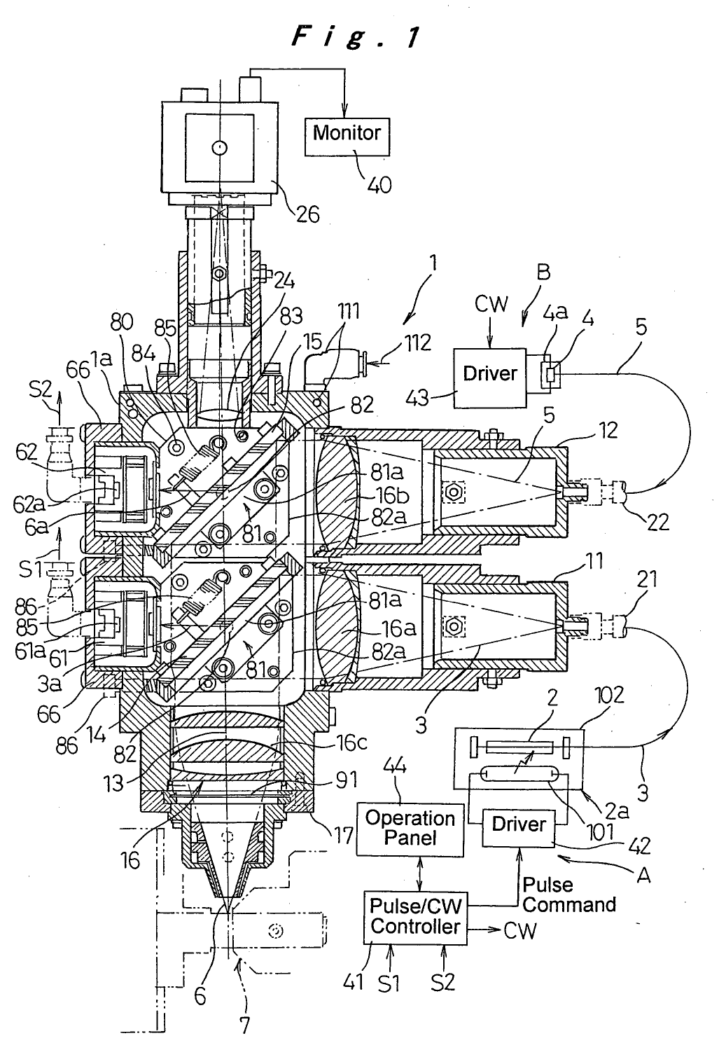

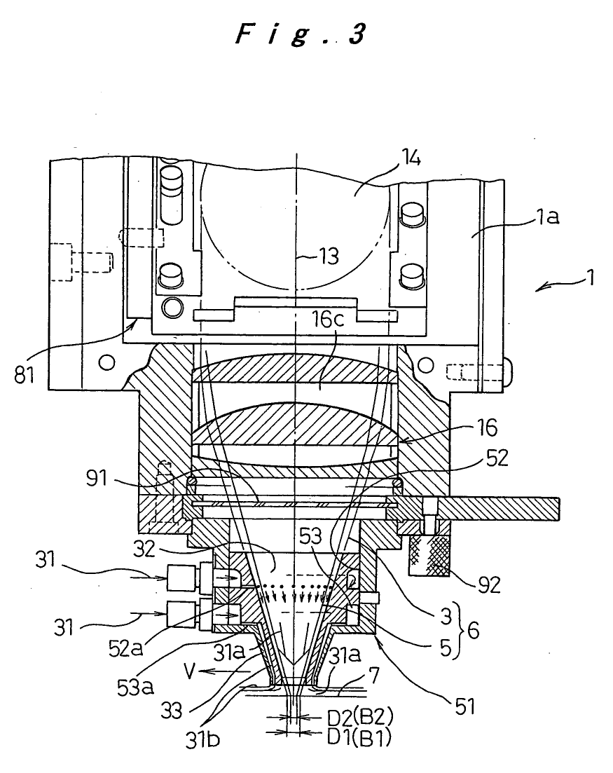

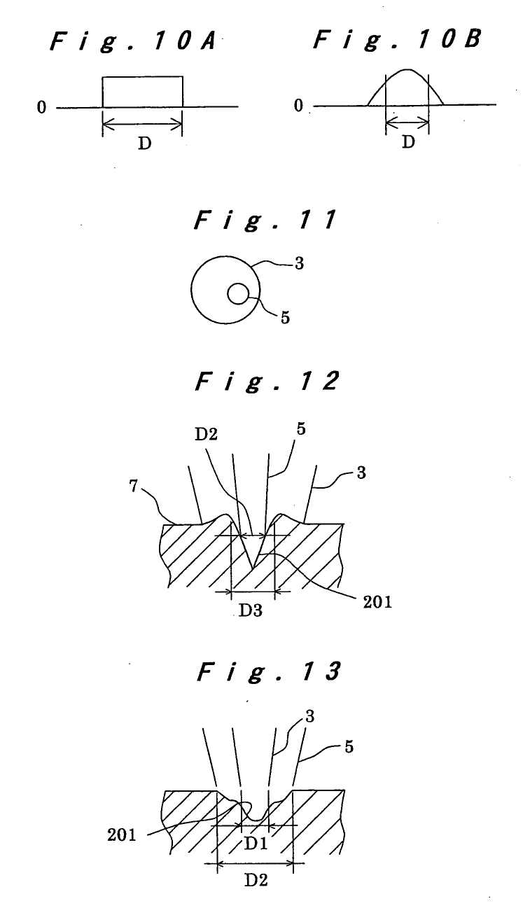

Referring to FIG. 1 which illustrates a hybrid laser torch 1 used in one embodiment of the hybrid laser processing method, first and second laser beams 3 and 5 from two different laser systems A and B are emitted as a hybrid laser beam 6 to a workpiece 7 for the processing. As shown in FIG. 3, the focus diameter, or the effective spot size D2, of the second laser beam 5 on the workpiece 7 is smaller than the effective spot size D1 of the first laser beam 3. The “effective spot size” here means the size of the laser beam 3 or 5 that is effectively emitted on the workpiece 7. If the laser beam has a homogenous intensity distribution (top-hat) as shown in FIG. 10A, the entire laser spot will be regarded as an effective spot size D. If the laser beam has a Gaussian intensity distribution where the intensity is higher in the center as shown in FIG. 10B, the size of the central portion with effective intensity will be the effective spot size D. The spot size D is not necessarily in the form of a true circle.

Thus the first and second laser beams from two different laser systems A and B are superposed and irradiated as a hybrid laser beam on the workpiece, wherein the two laser beams respectively have large and small spot sizes D1 and D2, whereby the center of the laser beam spot is processed faster than the surrounding area, which accelerates the processing and increases penetration. Processing with a first laser beam 3 from the laser system A that is a solid-state laser medium 2 and a second laser beam 5 from the laser system B that is a laser diode 4 is particularly effective for the following reasons: Laser system A is capable of high power output and the first laser beam 3, with its large effective spot size D1, can achieve a necessary processing width B1 and strength V required for seal-welding. The second laser beam 5, which is with lower output than the first laser beam 3, is focused in the smaller effective spot size D2 to concentrate energy to a specific area B2. Therefore, while the first laser beam 3 covers the entire processing width B1, the second laser beam 5 increases the processing speed in the limited area B2, as compared to the case where the focus diameter D2 of the second laser beam 5 is the same as the focus diameter D1 of the first laser beam 3. As a result, even with lower output, the second laser beam 5 contributes largely to an increase in processing speed and depth in the area B2 as it is superposed with the first laser beam 3, whereby it is possible to process a metal material having high reflectivity such as aluminum with a sufficient weld width, or penetration width B1, and penetration depth, and at high speed. Also, the processing of the specific area B2 with accelerated speed and increased penetration using the hybrid laser beam effectively suppresses generation of sputtered particles.

The ratio of D2 to D1 should preferably be in the range of 0.2≦D2/D1≦0.8. The second laser beam 5 should be emitted such that its effective spot is positioned inside the effective spot of the first laser beam 3 as shown in FIG. 11. This way, a keyhole 201 is formed in the spot center as shown in FIG. 12, which grows in depth and further accelerates the processing speed and increases penetration.

The effective spot size D2 of the second laser beam 5 is equal to or smaller than the size D3 of the keyhole 201 which is formed during the process as shown in FIG. 12. This enables further concentration of optical energy, whereby the keyhole 201 is maintained even between pulses of the first laser beam 3, and porosity formation, which is caused by metal vapor entrapped in closed keyholes 201, is prevented. Thus faults resulting from porosity is prevented.

For this purpose, the second laser beam should preferably be targeted at the position of the keyhole formed during the process. As the processing speed increases, the keyhole position moves forward. Therefore, the second laser beam should be adjusted to always match the position of the keyhole to keep preferable processing conditions irrespective of the speed.

FIG. 1 to FIG. 7 illustrate a hybrid laser torch 1 with which the above method of hybrid laser processing is performed. Referring to FIG. 1, the torch main body 1a includes a laser emitting end 17 for emitting a hybrid laser beam 6; first and second introducing units 11 and 12 for introducing first and second laser beams 3 and 5 from two different laser systems A and B; first and second mirrors 14 and 15 positioned in series along the optical axis 13 for reflecting the first and second laser beams 3 and 5 from the first and second laser introducing units 11 and 12 and for superposing and irradiating these laser beams as a hybrid laser beam 6; and a focus lens system 16 for focusing the hybrid laser beam 6 onto a workpiece 7 such that the focus diameter or effective spot size D2 of the second laser beam 5 is smaller than the focus diameter or effective spot size D1 of the first laser beam 3. The focus lens system 16 consists of collimate lenses 16a and 16b that cause the spreading first and second laser beams 3 and 5 from the first and second laser introducing units 11 and 12 to travel parallel into the first and second mirrors 14 and 15, and a converging lens 16c for converging the two laser beams from the first and second mirrors 14 and 15 as the hybrid laser beam 6 onto the workpiece 7. The hybrid laser torch is therefore in the form of the letter L, and both collimate lenses 16a and 16b are aligned in series along the optical axis 13 together with the mirrors 14 and 15 so that the hybrid laser torch 1 is not unnecessarily long. Also, the hybrid laser beam 6 does not pass through the collimate lens 16a.

Thus, the first and second laser beams 3 and 5 are independently introduced into the hybrid laser torch 1, superposed therein, and emitted as a hybrid laser beam 6 onto the workpiece 7. Superposing the two laser beams 3 and 5 having different characteristics into the hybrid laser beam 6 at the last stage has the following advantages: In the case with using optical fibers 21 and 22, for example, the type of the light paths and the core diameter can be variously changed to achieve the best effects of the characteristics of respective laser beams. The laser beam characteristics are not lost or degraded because the beams are not superposed from an earlier stage and do not travel a long common transmission path. Also, adverse effects of high energy on the surrounding structure are avoided.

The light source of laser system A is a solid-state laser medium or laser oscillator such as YAG 2, and the first laser beam 3 is guided by a GI (grated index) or SI (step index) optical fiber 21. The second laser beam 5 is guided by a GI optical fiber 22 in laser system B. These beams are superposed and focused onto the workpiece 7 using the same focus lens system 16, which is designed to focus the first laser beam with a predetermined focus diameter D1. Therefore, the second laser beam 5 is also passed through the same focus lens system 16, but focused with a smaller focus diameter because of a difference in the wavelength. The GI optical fiber 22 has high focusing properties and focuses the second laser beam 5 with a smaller focus diameter, whereby the laser energy is easily concentrated to a specific area B2. The first laser beam 3 may also be guided by a GI optical fiber so that it is focused more easily, but only if necessary, as it can be guided with an SI optical fiber with no particular problems. Thus, the first laser introducing unit 11 is connected to the YAG oscillator 2a via a GI or SI optical fiber 21, and the second laser introducing unit 12 is connected to the LD oscillator 4a via a GI optical fiber 22.

To satisfy the above-mentioned relationship between D1 and D2, it is preferable to use an SI optical fiber for the first laser beam 3 to create a top-hat spot, and a GI optical fiber for the second laser beam 5 to create a Gaussian spot. The fiber diameter and the fiber NA for the first laser beam 3 should be equal to or larger than those for the second laser beam 5. The f-number of the collimate lenses for the first laser beam 3 should be equal to or smaller than that for the second laser beam 5.

The first laser beam 3 is a pulsed laser; its output power is controlled by adjusting laser pulses. The second laser beam 5 is a CW laser output with wavelength control. Using a single controller 41 that controls both pulse and wavelength, as shown in FIG. 1, or independent controllers, the solid-state laser medium such as the YAG oscillator 2a is pulsed through a driver 42, and the LD oscillator 4a or the like is controlled through a driver 43.

Thus, while the CW laser energy is constantly concentrated on a specific area B2 in the processing width B1 to continuously perform a supplementary process suitable for the low output of the second laser beam 5, the instantaneous, high power output of the pulsed laser is repeatedly applied over the entire processing area to achieve a large processing width B1 and high processing speed V. Meanwhile, the second laser beam 5 proceeds the processing of the specific area B2, accelerating the processing speed and increasing penetration by the hybrid laser beam effect. That is, the continuous emission of the second laser beam 5 or the CW laser maintains the keyhole 201, which may close between pulses if there is only the first laser beam 5, or the intermittent pulsed laser beam, whereby the processing is made stable.

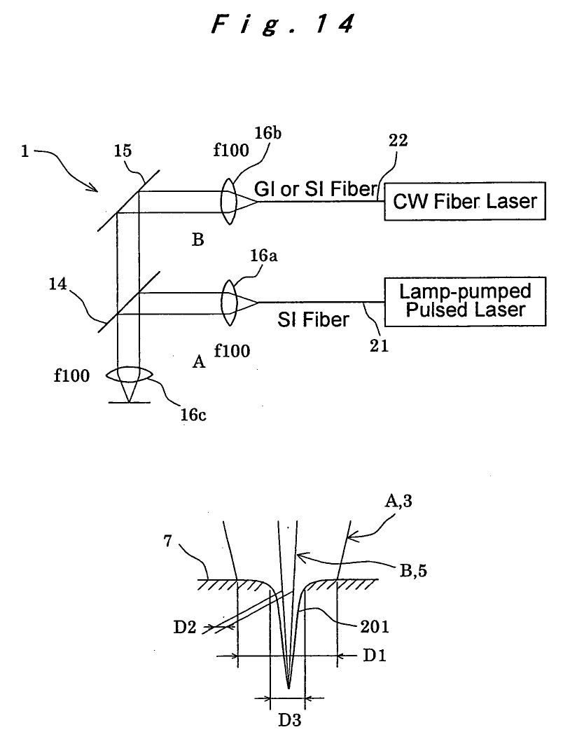

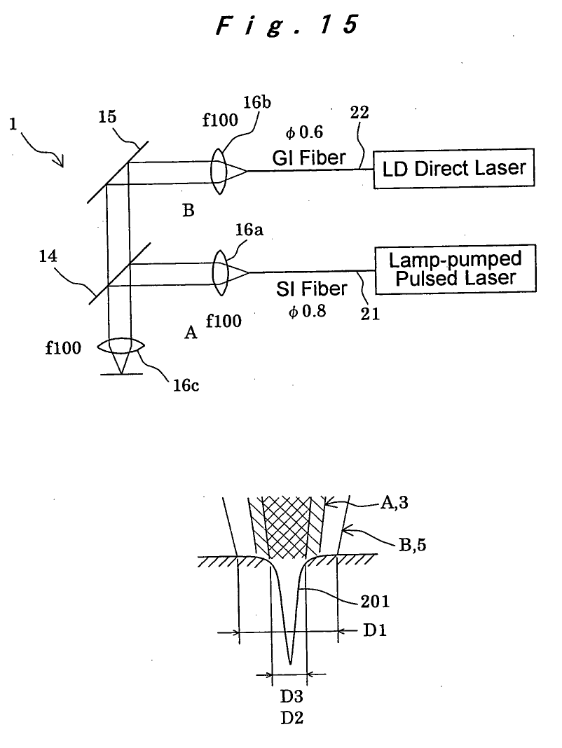

The present invention is not limited to the above embodiment. Even if the effective spot size D1 of the first laser beam 3 or pulsed laser beam is smaller than that of the second laser beam 5 or CW laser beam as shown in FIG. 13, a keyhole is readily formed because of a temperature rise in the spot center. However, as described above and as is seen from FIG. 12 in comparison with FIG. 13, a deeper keyhole 201 is readily formed if the effective spot size D2 of the second laser beam 5 or CW laser beam is smaller than the effective spot size D1 of the first laser beam 3 or pulsed laser beam.

Means of irradiating the pulsed laser beam in the laser system A includes a lamp-pumped pulsed YAG, a pulse-pumped laser, and a pulsed fiber laser, and a pulsed laser beam is an intermittently output laser beam. Means of irradiating the CW laser beam in the laser system B includes an LD direct laser, an LD-pumped CW laser, and a CW fiber laser, and a CW laser beam is a continuously emitted laser beam, including laser with modulated power. The fiber laser is an optical fiber made of a laser medium; a light amplification and oscillation take place within the fiber. The fiber laser includes the pulsed fiber laser and CW fiber laser, as mentioned above.

As the first mirror 14 is positioned forward of the second mirror 15, the first mirror 14 is provided with an HR coating for a laser beam 3 from a solid-state laser medium such as YAG and an AR coating for the LD laser beam 5. The second mirror 15 is provided with an HR coating for the LD laser beam. Alternatively, the first mirror 14 may be positioned behind the second mirror 15, and provided with an HR coating for a YAG laser beam, and the second mirror 15 may be provided with an HR coating for the LD laser beam and an AR coating for the solid-state laser beam 3. These coatings, combined with different wavelengths of the first and second laser beams 3 and 5 and the reflection and transmission characteristics of the first and second mirrors 14 and 15 corresponding to their positions, reduce energy loss of the first and second laser beams, and increase energy efficiency, irrespective of which mirror is positioned forward on the optical axis 13. For this purpose, both the first and second mirrors 14 and 15 should preferably be directed at 45° relative to both of the laser beams 3 and 5 and to the optical axis 13.

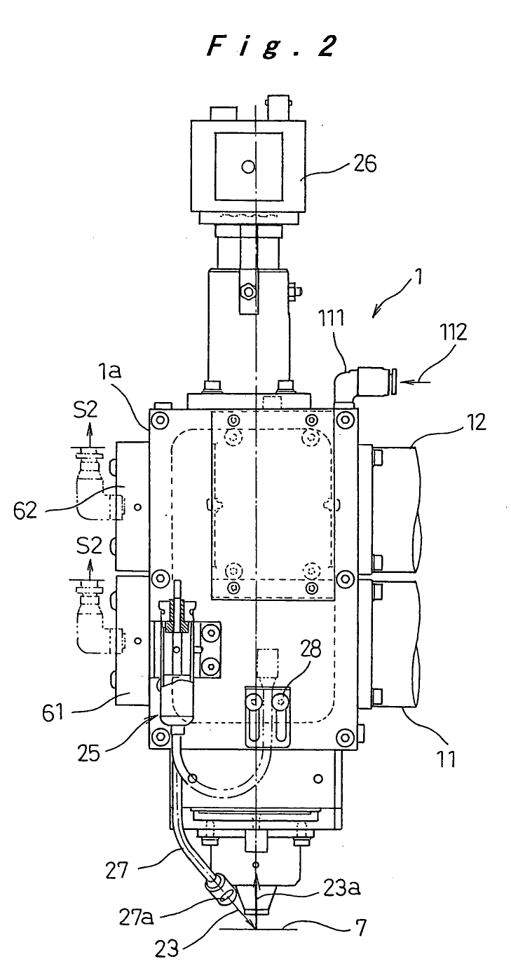

Referring now to FIG. 2, the processing position on the workpiece 7 is illuminated with a light beam 23, its reflection light 23a being transmitted through the first and second mirrors 14 and 15 shown in FIG. 1. An image of the workpiece is formed using an achromatic lens 24 with a smaller diameter than the converging lens 16c, or instead a small aperture that works as a pinhole, so that the processing state is monitored and the processing conditions adjusted in accordance with the monitored image. When the workpiece 7 is illuminated, the reflection light 23a travels back through the converging lens 16c and reaches the first and second mirrors 14 and 15, but it is passed through the mirrors 14, 15 and guided to the outside of the optical system and used for forming an image for the monitoring purpose so that the processing conditions is adjusted. With such colorless achromatic lens 24 with a smaller diameter than the converging lens 16c, or a pinhole, a clear image is formed with a large focal depth, while achieving satisfactory reflection and transmission characteristics of the converging lens 16c and the first and second mirrors 14 and 15, and thus the monitoring is performed easily and appropriately.

The hybrid laser torch 1 as shown in FIG. 1 includes a monitor camera 26 for the monitoring purpose disposed outside the torch main body 1a, in which an image of the workpiece 7 is formed by its reflection light 23a, as shown in FIG. 2. As shown in FIG. 1, image information from the monitor camera 26 is output to a monitor 40 for visual recognition from outside, and the output power of the YAG oscillator 2a and LD oscillator 4a is adjusted through an operation panel 44 connected to the controller 41.

The illuminator 25 shown in FIG. 2 emits a white light from a white LED as the light beam 23 introduced via an optical fiber 27. The white LED light beam 23 is precisely guided by the optical fiber 27 toward the area on the workpiece 7 that is processed with the hybrid laser beam 6 without interfering anything, so that, even when the processed part of the workpiece 7 does not undergo oxidation and maintains a luminance surface, the white light reduces glare, and flicker-free, halation-free images of the surface of the workpiece being processed are clearly formed in the monitor camera 26, for easy and correct visual recognition of the processed surface. The optical fiber 27 includes a condenser 27a at its tip for efficient illumination. A fiber holder 28 is provided on the torch main body 1a near the illuminator 25 so that the optical fiber 27 when not in use is temporarily accommodated as indicated by the imagenally line in FIG. 2 so as to prevent the optical fiber from interfering with other objects or from being damaged by collision with other objects.

FIG. 3 shows the laser emitting end in detail. Inactive gas 31 such as N₂ is supplied to fill a tapered center passage 32 and continuously ejected as a tapered center jet 31a, while the hybrid laser beam 6 is being projected through the tapered center passage 32 onto the workpiece 7. At the same time, a truncated-cone shaped, annular passage 33 formed around the center passage 32 continuously ejects inactive gas 31 such as to form a film current 31b surrounding the hybrid laser beam 6 and the center jet 31a. The tapered center jet 31a of inactive gas continuously ejected from the center passage 32 protects the optical system from sputtered particles that may be generated at the processed area. As the center jet 31a is surrounded by the film current 31b ejected from the truncated-cone shaped, annular passage 33, it does not entrap air outside. When it reaches the processed surface of the workpiece 7, the center jet spreads while purging air, thereby causing the film current 31b also to spread around, which keeps covering the entire surface of the spread center jet 31a until the jet reaches the workpiece 7. The jet thus eliminates air between the laser emitting end and workpiece 7, whereby oxidation of the processed area of the workpiece 7 is prevented, weld failures or cracks resulting from oxidation are prevented, and the processed area maintains a luminance surface.

For this purpose, the hybrid laser torch 1 shown in FIG. 1 includes a coaxial double nozzle 51 at the laser emitting end 17 of the torch main body 1a, as shown in FIG. 3. The nozzle includes a tapered center passage 32, which is arranged along the optical axis 13 and through which the hybrid laser beam 6 passes, and which ejects supplied inactive gas 31 continuously as a tapered center jet 31a. The nozzle further includes a truncated-cone shaped, annular passage 33 around the center passage 32, which ejects inactive gas 31 continuously such as to form a film current 31b surrounding the hybrid laser beam 6 and the center jet 31a.

Outer circumferential annular passages 52 and 53 are formed around the center passage 32 and annular passage 33, communicating therewith via circumferentially arranged small holes 52a and 53a, so as to fill the center passage 32 and annular passage 33 with supplied inactive gas 31 in a circumferential direction. The inactive gas 31 fills the annular passage 52 first and then enters under pressure into the center passage 32 instantly and evenly from the multiple, circumferential small holes 52a, and exits as the center jet 31a that does not contain air. Similarly, the inactive gas 31 is supplied into the annular passage 53, introduced under pressure into the annular passage 33 instantly and evenly from the multiple, circumferential small holes 53a, and ejected as the film current 31b that does not contain air. The film current 31b is converged by the truncated-cone shape and ejected immediately around the center jet 31a. This ensures the shielding effect for the molten weld pool in the processed area.

The hybrid laser torch 1 further includes a first sensing part 61 for sensing part of light 3a of the first laser beam 3 transmitted through the first mirror 14, and a second sensing part 62 for sensing part of light 6a of the second laser beam 5 transmitted through the second mirror 15. The percentage of the first and second laser beams 3 and 5 being transmitted through the first and second mirrors 14 and 15 is about 1%, which is a slight amount and does not cause significant output loss. The energy level of the first and second laser beams 3 and 5 is thus monitored and the data is used for determining laser output status and optical fiber transmission status. Detection signals S1 and S2 are input to the controller 41 for feedback control of output power of the YAG oscillator 2a and LD oscillator 4a in respective laser systems A and B, or for executing emergency stop of the oscillators, or for sending maintenance instructions to the operation panel 44 and monitor 40.

The first and second sensing parts 61 and 62 consist of photo diodes 61a and 62a, respectively. Since the first mirror 14 is arranged forward of the second mirror 15, the photo diode 61a receives light through a visible light cut filter 64 and a filter 63 with an HR coating that provides reflectivity relative to both of the LD beam 5 and the solid-state laser beam 3, as shown in FIG. 7. The second sensing part 62 receives light through a visible light cut filter 64 and a filter 65 with an HR coating that provides reflectivity relative to the solid-state laser beam 3. This filter and coating combination may be reversed in accordance with the relative positions of the first and second mirrors 14 and 15 along the optical axis 13. This way, irrespective of which mirror is positioned forward, even when the laser beams that have reached the workpiece 7 and passed through the monitor camera 26 or ambient light reach the first and second sensing parts 61 and 62 through the first and second mirrors 14 and 15, these light rays are filtered away so that sensing is performed correctly. The first and second sensing parts 61 and 62 are further covered by a detachable hood 66 as shown in FIG. 1 to prevent adverse effects of ambient light and dust around the hybrid laser torch.

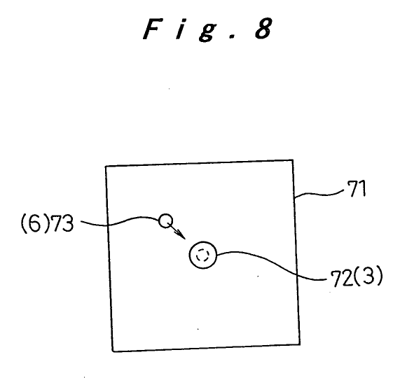

Before the actual processing, the orientation of one of the mirrors is adjusted. A laser mark 72 is produced on a test specimen 71 shown in FIG. 8 using one laser beam emitted through the mirror that is arranged more forward along the optical axis, and then, another laser beam is emitted through the mirror that is arranged behind the other. The mirror direction is adjusted so that the laser position 73 of the latter laser beam is within a specified area indicated by the dotted line inside the laser mark 72, while monitoring the image on monitor 40. The first and second mirrors 14 and 15 and the focus lens system 16 are designed to superpose two laser beams 3 and 5 along the optical axis and to focus the hybrid laser beam 6 and they are set in standard relative positions, but in actual use, there may be the case where the two laser positions do not match because of various other conditions. Therefore, before actual use, the first and second laser beams 3 and 5 are first emitted one after another to check the laser position 73 of one laser beam relative to the laser mark of the other laser beam 72 from the monitor image. As described above, one of the first and second mirrors 14 and 15 is adjusted, so that the position of laser 73 emitted afterward is moved to a correct position relative to the laser mark 72 to match the two laser positions, whereby it is ensured that the processing afterward is carried out as intended. Since one of the first and second mirrors 14 and 15, which is arranged behind the other along the optical axis 13, i.e., away from the target, is adjusted in position, the laser position is easily adjustable because the farther the mirror is positioned from the target, the more the laser position is displaced in accordance with the mirror direction. Moreover, the mirror direction is adjusted without causing any influence on the laser beam emitted through the mirror that is arranged forward on the optical axis.

In this embodiment, because the first mirror 14 is arranged forward, the laser mark 72 is formed by the first laser beam 3 and then the laser position 73 of the second laser beam 5 is adjusted, but it goes without saying that, with a reversed mirror arrangement, the laser mark 72 will be formed by the second laser beam 5 and the laser position 73 of the first laser beam 3 will be adjusted.

To perform the above method, the hybrid laser torch 1 includes a mirror adjusting unit 81 as shown in FIG. 1 and FIG. 3 to FIG. 5, and at least one of the mirrors 14 and 15 that is arranged behind the other on the optical axis 13 is supported on this adjusting unit 81. Depending on the case, both of the first and second mirrors 14 and 15 may be supported on such adjusting unit 81, as shown in the drawings. The adjusting unit 81 at least includes a rotatable adjusting part 81a that rotates around a shaft 82 orthogonal to the optical axis 13 for adjusting the direction of the mirror surface. The example shown in the drawings further includes an angle adjusting unit 81b that allows the mirror surface to be adjusted in various directions relative to the optical axis 13.

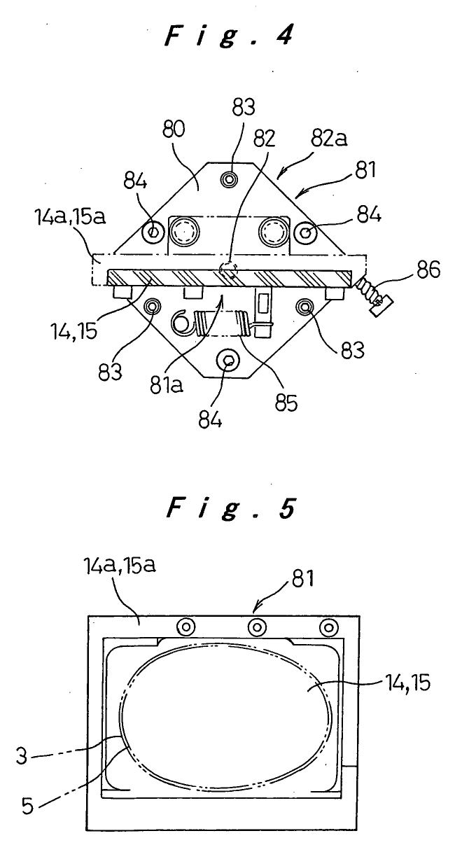

The angle adjusting unit 81b includes a mounting base 80 of the mirror frame 14a or 15a, three attachment screws 83 for attaching the mounting base 80 to the torch main body 1a, and three adjusting screws 84 for adjusting the position of the mounting base 80 relative to the torch main body 1a. The adjusting screws 84 protrude toward the torch main body 1a. By turning each of these adjusting screws 84 as required, the mounting base 80 is inclined to the attachment surface of the torch main body 1a and to the optical axis 13 in any directions, and after adjusting the direction, the mounting base is secured by the attachment screws 83. The rotatable adjusting part 81a supports the mirror frame 14a or 15a on the mounting base 80 such as to be rotatable around the shaft 82. The mirror frame 14a or 15a is biased to one direction around the shaft 82 by a spring 85, and abutted on a screw 86 that is screwed from outside of the torch main body 1a as shown in FIG. 1 and FIG. 4. This screw protruding inside of the torch main body 1a is adjusted to turn the mirror 14 or 15 around the shaft 82 to adjust the mirror direction.

The angle adjusting unit 81b allows the mirror 14 or 15 to be adjusted in any directions, which is a suitable design for the manufacturer for performing the above-mentioned standard mirror positioning. The hybrid laser torch is usable with this design, as the user need only turn the mirror around the shaft 82 for the final adjustment before actual use, but this is obviously not a requirement.

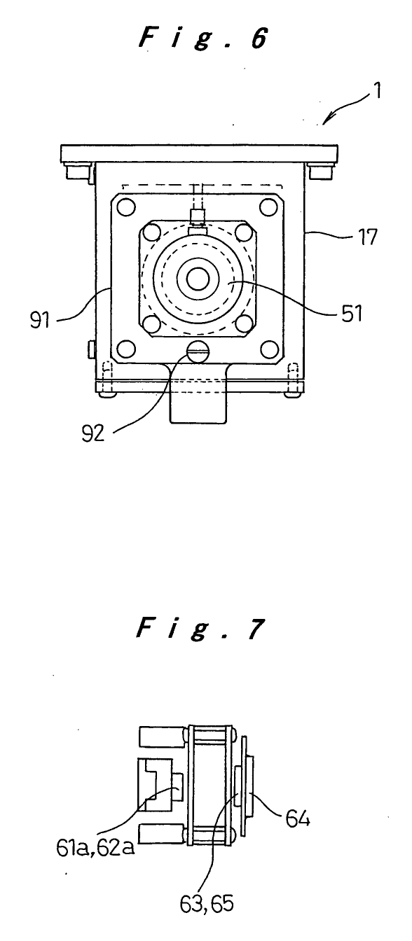

Between the converging lens 16c and the nozzle 51 is inserted a removable filter 91 as shown in FIG. 1, FIG. 3, and FIG. 6, which is secured in place with a screw 92, to further prevent sputtered particles or the like from entering the optical system. The torch main body 1a includes water cooling passages 111, through which cooling water 112 is supplied for the cooling purpose.

To obtain a laser beam 3, light from a pump lamp 101 is irradiated on the YAG 2 with a smaller focus diameter than the outside diameter of the YAG 2, using the reflective surface of the laser condenser 102 having an oval cross section as shown in FIG. 1. The present inventors have proposed using a pump lamp 101 with a light emission diameter that is smaller than the outside diameter of the YAG 2, which has the following advantages: The pumped area on the YAG 2 is limited to the focus diameter of the lamp. The outer circumferential area of the YAG is not pumped, and a decrease in the pumped area means less heat distortion. Deflection caused by one-sided, unbalanced pumping is reduced. As a result, even with one pump lamp 101 for pumping from one side, the YAG has longer life, and is increased in length to have increased volume and output power. Thereby, the YAG oscillator 2a is made more simple, small-sized, and low-cost, and the YAG with a diameter of 7 mm or less, which enables a 0.6 mm or less focus spot diameter, is used. As the drive current of the pump lamp 101 is reduced by the amount of increased output, the running cost is reduced. A high-speed IGBT is used for the driver 42 for high frequency power switching.

The YAG 2 is 180 mm or more in length to have increased gain and the output efficiency is about 4%, which was conventionally about 3%, whereby the output power is 1 KW or more. Because of the decrease of heat distortion, the service life is increased to several hundred million shots, which is several times more than the conventional system. Further, the outside diameter can be made 7 mm or smaller to achieve a focus diameter of 0.6 mm or smaller to the optical fiber 21 or the like.

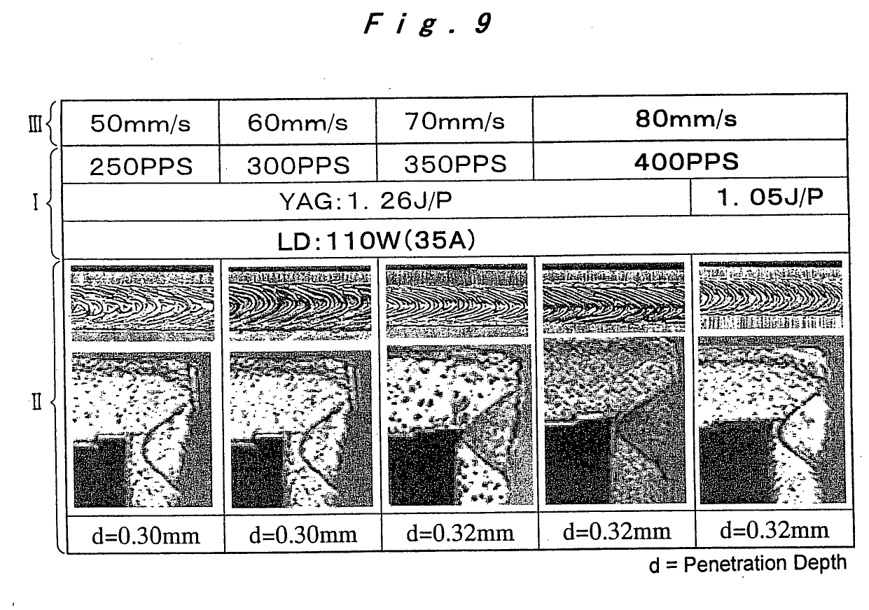

FIG. 9 shows some results of welding using such YAG 2. As can be seen, the welding results were favorable in terms of external appearance, weld width, and weld depth d (see II in FIG. 9). The welding speed was varied (III) in accordance with the number of pulses of the YAG laser (I). LD laser was emitted with a fixed output power, and YAG laser was emitted at two output levels.

FIG. 14 shows one example of preferable combination of laser systems A and B: A lamp-pumped pulsed-laser and a CW fiber laser. The optical fiber 21 for the first laser beam 3 is a 0.8 mm diameter SI fiber and the optical fiber 22 for the second laser beam 5 is a 0.05 mm diameter SI or GI fiber. The f-number of the collimate lenses 16a and 16b, and the converging lens 16c is 100. With this combination, the effective spot size D2 is made small enough relative to the diameter D3 of the keyhole 201.

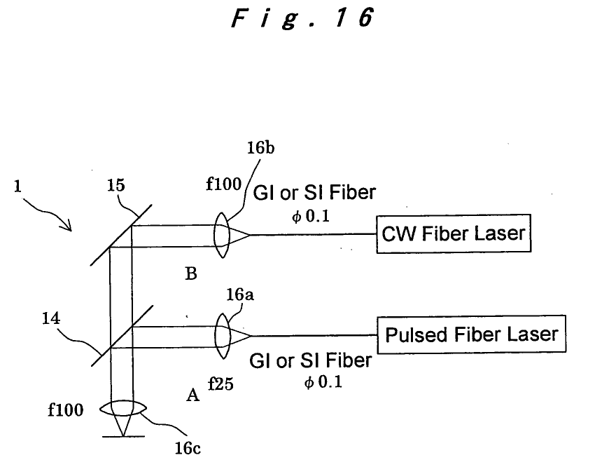

FIG. 15 shows another example of preferable combination of laser systems A and B: A lamp-pumped pulsed laser and an LD direct laser. The optical fiber 21 for the first laser beam 3 is a 0.8 mm diameter SI fiber and the optical fiber 22 for the second laser beam 5 is a 0.6 mm diameter GI fiber. The f-number of the collimate lenses 16a and 16b, and the converging lens 16c is 100. With this combination, the effective spot size D2 is made almost equal to the diameter D3 of the keyhole 201.

FIG. 16 shows yet another example of preferable combination of laser systems A and B: A pulsed fiber laser and a CW fiber laser. The optical fiber 21 for the first laser beam 3 is a 0.1 mm diameter GI or SI fiber and the optical fiber 22 for the second laser beam 5 is a 0.1 mm diameter GI or SI fiber. The f-number of the collimate lens 16b and the converging lens 16c is 100, and the f-number of the collimate lens 16a is 25.

As described above, with the hybrid laser processing method of the present invention, welding is performed with a satisfactory weld width or penetration width and penetration depth and at high speed. The processing using a hybrid laser beam emitted to a specific area with accelerated speed and increased penetration effectively suppresses generation of sputtered particles. With the inactive gas supply structure of the invention, even if sputtered particles are generated from the workpiece that is being processed with the hybrid laser beam, the center jet of gas prevents the sputtered particles from reaching the optical system. The center jet, together with the film current that surrounds the center jet, ensures that the processed area of the workpiece does not undergo oxidation, whereby weld failures or cracks resulting from oxidation are prevented, and also, the processed area maintains a luminance surface.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. A hybrid laser processing method comprising:
processing a workpiece by superposing and irradiating a first laser beam and a second laser beam from two different laser systems on the workpiece as a hybrid laser beam, wherein
the first laser beam and the second laser beam are irradiated at the same time to the same position on the workpiece such that an effective spot size D2 of the second laser beam is smaller than an effective spot size D1 of the first laser beam.

2. The hybrid laser processing method according to claim 1, wherein:
a ratio of the effective spot size D2 to the effective spot size D1 is in a range of 0.2≦D2/D1≦0.8; and
the second laser beam is emitted such that an effective spot thereof is positioned inside an effective spot of the first laser beam.

3. The hybrid laser processing method according to claim 1, wherein
the effective spot size D2 of the second laser beam is equal to or smaller than a size D3 of a keyhole which is formed during the process.

4. The hybrid laser processing method according to claim 1, wherein
the first laser beam and the second laser beam are independently introduced into one hybrid laser torch, superposed therein, and emitted as a hybrid laser beam onto the workpiece.

5. The hybrid laser processing method according to claim 1, wherein:
the first laser beam is a pulsed laser beam, an output power thereof being controlled by adjusting laser pulses; and
the second laser beam is a CW laser beam output with wavelength or modulation control.

6. The hybrid laser processing method according to claim 5, wherein:
means of irradiating the pulsed laser beam includes a lamp-pumped pulsed YAG, a pulse-pumped laser, and a pulsed fiber laser, a pulsed laser beam being intermittently output;
means of irradiating the CW laser beam includes an LD direct laser, an LD-pumped CW laser, and a CW fiber laser, the CW laser beam being continuously emitted.

7. The hybrid laser processing method according to claim 1, wherein:
a light source of the first laser beam is a solid-state laser medium or laser oscillator such as YAG; and
the first laser beam is guided by any one of GI and SI optical fiber and the second laser beam is guided by a GI optical fiber so that the first laser beam and the second laser beam are superposed and focused onto the workpiece using a focus lens system, which is designed to focus the first laser beam with a predetermined focus diameter.

8. The hybrid laser processing method according to claim 1, wherein:
a processing position on the workpiece is illuminated; and
its reflection light is used to form an image of the workpiece using any one of an achromatic lens with a smaller diameter than lenses of the focus lens system and a small aperture, so that a processing state can be monitored to adjust processing conditions in accordance with the monitored image.

9. The hybrid laser processing method according to claim 1, wherein:
an inactive gas is supplied to a tapered center passage and continuously ejected as a tapered center jet, while the hybrid laser beam is being projected through the tapered center passage onto the workpiece; and
at the same time, a truncated-cone shaped, annular passage formed around the center passage continuously ejects an inactive gas such as to form a film current surrounding the hybrid laser beam and the center jet.

10. A hybrid laser torch comprising:
a torch main body having a laser emitting end for emitting a hybrid laser beam;
a first laser introducing unit and a second laser introducing unit for introducing laser beams from two different laser systems;
a first mirror and a second mirror positioned in series along an optical axis for reflecting a first laser beam and a second laser beam from the first laser introducing unit and the second laser introducing unit and for superposing and irradiating the first laser beam and the second laser beam as a hybrid laser beam; and
a focus lens system for focusing the hybrid laser beam onto a workpiece such that an effective spot size D2 of the second laser beam is smaller than an effective spot size D1 of the first laser beam, wherein
the first laser introducing unit and the second laser introducing unit, the first mirror and the second mirror, and the focus lens system are contained in the torch main body.

11. The hybrid laser torch according to claim 10, wherein:
the first laser beam is a laser beam from a solid-state laser medium such as YAG; and
the first laser introducing unit is connected to a light source for the first laser beam via any one of GI and SI optical fiber, and the second laser introducing unit should be connected to a light source for the second laser beam via a GI optical fiber.

12. The hybrid laser torch according to claim 10, wherein:
a light source for the first laser beam is controlled by adjusting laser pulses for output; and
a light source for the second laser beam is controlled by a CW control for output.

13. The hybrid laser torch according to claim 10, comprising a mirror adjusting unit, on which at least one of the first mirror and the second mirror that is arranged behind the other on an optical axis is supported.

14. The hybrid laser torch according to claim 10, wherein:
the first mirror is positioned forward of the second mirror;
the first mirror is provided with an HR coating for a laser beam from a solid-state laser medium such as a YAG laser beam and an AR coating for an LD laser beam; and
the second mirror is provided with an HR coating for an LD laser beam.

15. The hybrid laser torch according to claim 10, wherein:
the first mirror is positioned behind the second mirror;
the first mirror is provided with an HR coating for a YAG laser beam; and
the second mirror is provided with an HR coating for an LD laser beam and an AR coating for solid-state laser.

16. The hybrid laser torch according to claim 10, comprising:
an illuminator for illuminating the processing position on the workpiece;
any one of an achromatic lens having a smaller diameter than the lenses of the focus lens system and a small aperture, for forming an image using reflection light from the illuminated object that is passed through the first and second mirrors; and
a monitor camera for displaying the formed image for the monitoring purpose.

17. The hybrid laser torch according to claim 10, comprising:
a first sensing part for sensing part of light of the first laser beam transmitted through the first mirror; and
a second sensing part for sensing part of light of the second laser beam transmitted through the second mirror.

18. The hybrid laser torch according to claim 17, wherein:
the first mirror is arranged forward of the second mirror, and the first sensing part receives light through a visible light cut filter and a filter with an HR coating for laser beams from an LD laser beam and from a solid-state laser medium such as a YAG laser beam; and
the second sensing part receives light through a visible light cut filter and a filter with an HR coating for the solid-state laser beam.

19. The hybrid laser torch according to claim 17, wherein:
the first mirror is arranged behind the second mirror, and the first sensing part receives light through a visible light cut filter and a filter with an HR coating for an LD beam; and
the second sensing part receives light through a visible light cut filter and a filter with an HR coating for laser beams from an LD laser beam and from a solid-state laser medium such as a YAG laser beam.

20. The hybrid laser torch according to claim 10, comprising a coaxial double nozzle at the laser emitting end of the torch main body, the coaxial double nozzle including:
a tapered center passage, which is arranged along the optical axis and through which the hybrid laser beam passes, and which ejects a supplied inactive gas continuously as a tapered center jet; and
a truncated-cone shaped, annular passage around the center passage, which ejects an inactive gas continuously such as to form a film current surrounding the hybrid laser beam and the center jet.
